(19) United States
(12) Patent Application Publication
(10) Pub. No.: US 2009/0101468 A1
(43) Pub. Date: Apr. 23, 2009

(54) Bill/coin processing system

(75) Inventors: Osamu Uehara, Hiratsuka-Shi (JP); Kazuhiro Doi, Himeji-Shi (JP); Kazuyuki Shimizu, Yashio-Shi (JP); Koichi Nishida, Ohta-Ku (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Glory Ltd., Himeji-Shi (JP)

(21) Appl. No.: 11/975,770

(22) Filed: Oct. 22, 2007

(51) Int. Cl. G07F 7/04

(52) U.S. Cl. 194/206

(57) ABSTRACT

Provided is a bill and coin processing system having: a bill change discharger constructed as a bill receiving/discharging machine; and a coin change discharger constructed as a coin receiving/discharging machine, wherein a machine dimension of each of the bill change discharger and the coin change discharger is that a width is equal to or smaller than 500 mm, a depth is equal to or smaller than 600 mm, and a height is equal to or smaller than 400 mm. Further provided is a similar bill and coin processing system, wherein money input/output ports of the bill change discharger and of the coin change discharger are disposed in positions, which are 700 mm through 1500 mm in height from a floor surface. Still further provided is a bill and coin processing system having: a bill change discharger constructed as a bill receiving/discharging machine; a coin change discharger constructed as a coin receiving/discharging machine; and a coin-roll box installed under the bill change discharger and the coin change discharger, wherein a machine dimension of each of the bill change discharger and the coin change discharger is that a width is equal to or smaller than 500 mm, a depth is equal to or smaller than 600 mm, and a height is equal to or smaller than 400 mm, and a box dimension of the coin-roll box is that a width is equal to or smaller than 1000 mm, a depth is equal to or smaller than 600 mm, and a height is equal to or smaller than 100 mm.

### BACKGROUND OF THE INVENTION

1. Field of the Invention

The present invention relates generally to a bill and coin processing system, and more particularly to a bill and coin processing system including a bill change discharger constructed as a bill receiving/discharging machine and a coin change discharger constructed as a coin receiving/discharging machine.

2. Background of the Invention

Shops etc in the distribution business widely employ a bill and coin processing system configured in combination with a POS (Point of Sales) terminal, which stores a received money and discharge the money as a transaction-based change.

Known as a typical bill and coin processing system in the distribution business is an electronic cash register with a change discharger according to U.S. Pat. No. 4,817,041 (Application Laid-Open No. 170,960/1984 of the equivalent basic application) filed by Sakamoto et al. A scheme of this system is that the change can be paid out in response to an instruction given from an upper terminal machine such as a POS register.

U.S. Pat. No. 6,474,546B1 (Niizuma) discloses a circulation type bill processing machine and U.S. Pat. No. 5,911,622 (Kinoshita et al.) discloses a circulation type coin receiving/discharging machine respectively by way of the prior arts of the bill change discharger and the coin change discharger. The bill change discharger and the coin change discharger are defined as a bill-dedicated machine and a coin-dedicated machine, and have respective sizes irrespective of each other.

Actual bill and coin processing entails paying a change both in bill and in coin. Hence, the payment of the change both in bill and in coin needs to install the bill and coin processing system configured by combining the bill change discharger and the coin change discharger.

Simply, however, the bill change discharger and the coin change discharger are arranged in a side-by-side relation, in which case a large installing area is required. In addition, the money receiving ports and the money repaying ports thereof are not rationally disposed, resulting in a decline of operability. Further, when the two machines are simply stacked and if these two machines have different sizes, the operability gets poor enough to disable the rational bill and coin processing to be done.

### SUMMARY OF THE INVENTION

Such being the case, it is an object of the present invention to provide a bill and coin processing system capable of executing a rational process with high operability by specifying dimensions, installing heights and a layout of a bill change discharger and of a coin change discharger.

According to a first aspect of the present invention, a bill and coin processing system comprises: a bill change discharger constructed as a bill receiving/discharging machine; and a coin change discharger constructed as a coin receiving/discharging machine, wherein a machine dimension of each of the bill change discharger and the coin change discharger is that a width is equal to or smaller than 500 mm, a depth is equal to or smaller than 600 mm, and a height is equal to or smaller than 400 mm.

The bill and coin processing system constructed of the bill change discharger and the coin change discharger each having the size described above can be compact in configuration as a whole, can have high flexibility and can exhibit high operability by prescribing the dimension.

According to a second aspect of the present invention, a bill and coin processing system comprises: a bill change discharger constructed as a bill receiving/discharging machine; and a coin change discharger constructed as a coin receiving/discharging machine, wherein money input/output ports of the bill change discharger and of the coin change discharger are disposed in positions, which are 700 mm through 1500 mm in height from a floor surface.

According to a third aspect of the present invention, a bill and coin processing system comprises: a bill change discharger constructed as a bill receiving/discharging machine; a coin change discharger constructed as a coin receiving/discharging machine; and a coin-roll box installed under the bill change discharger and the coin change discharger, wherein a machine dimension of each of the bill change discharger and the coin change discharger is that a width is equal to or smaller than 500 mm, a depth is equal to or smaller than 600 mm, and a height is equal to or smaller than 400 mm, and a box dimension of the coin-roll box is that a width is equal to or smaller than 1000 mm, a depth is equal to or smaller than 600 mm, and a height is equal to or smaller than 100 mm.

### BRIEF DESCRIPTION OF THE DRAWINGS

FIG. 1 is a block diagram showing an overall configuration of one embodiment of a bill and coin processing system according to the present invention;

FIG. 2 is a perspective view showing one example of an external appearance of a coin change discharger building up one embodiment of the bill and coin processing system according to the present invention;

FIG. 3 is a perspective view showing one example of an external appearance of a bill change discharger building up one embodiment of the bill and coin processing system according to the present invention;

FIG. 4 is a block diagram showing a control system building up one embodiment of the bill and coin processing system according to the present invention;

FIG. 5 is a perspective view showing one embodiment in which the coin change discharger and the bill change discharger in the bill and coin processing system according to the present invention are disposed in a side-by-side relation;

FIG. 6 is a perspective view showing another embodiment in which the coin change discharger and the bill change discharger in the bill and coin processing system according to the present invention are disposed in the side-by-side relation;

FIG. 7 is a perspective view showing one embodiment in which the coin change discharger and the bill change discharger orientated in directions opposite to each other in the bill and coin processing system according to the present invention, are disposed in the side-by-side relation;

FIG. 8 is a perspective view showing another embodiment in which the coin change discharger and the bill change discharger orientated in the directions opposite to each other in the bill and coin processing system according to the present invention, are disposed in the side-by-side relation;

FIG. 9 is a perspective view showing an embodiment in which a coil-roll drawer is installed under the coin change discharger and the bill change discharger that are disposed in the side-by-side relation, by way of a modified example of the embodiment illustrated in FIG. 6;

FIG. 10 is a perspective view showing an embodiment in which the coin change discharger is stacked on the bill change discharger;

FIG. 11 is a perspective view showing an embodiment in which the bill change discharger is stacked on the coin change discharger;

FIG. 12 is a perspective view showing an embodiment in which directions of the bill change discharger and the coin change discharger in the embodiment in FIG. 10 are opposite to each other;

FIG. 13 is a perspective view showing an embodiment in which the directions of the bill change discharger and the coin change discharger in the embodiment in FIG. 11 are opposite to each other;

FIG. 14 is a perspective view showing an embodiment in which the coin-roll drawer is installed under the coin change discharger, by way of a modified example of the embodiment illustrated in FIG. 11; and

FIG. 15 is a perspective view showing an embodiment of providing the bill change discharger constructed as a bill receiving/discharging machine and the bill change discharger constructed as a coin receiving/discharging machine and including a coin-roll box formed integrally with the coin change discharger.

### DETAILED DESCRIPTIONS OF THE EXEMPLARY EMBODIMENTS

Exemplary embodiments of a bill and coin processing system according to the present invention will hereinafter be described with reference to the drawings.

### (1) Overall Configuration

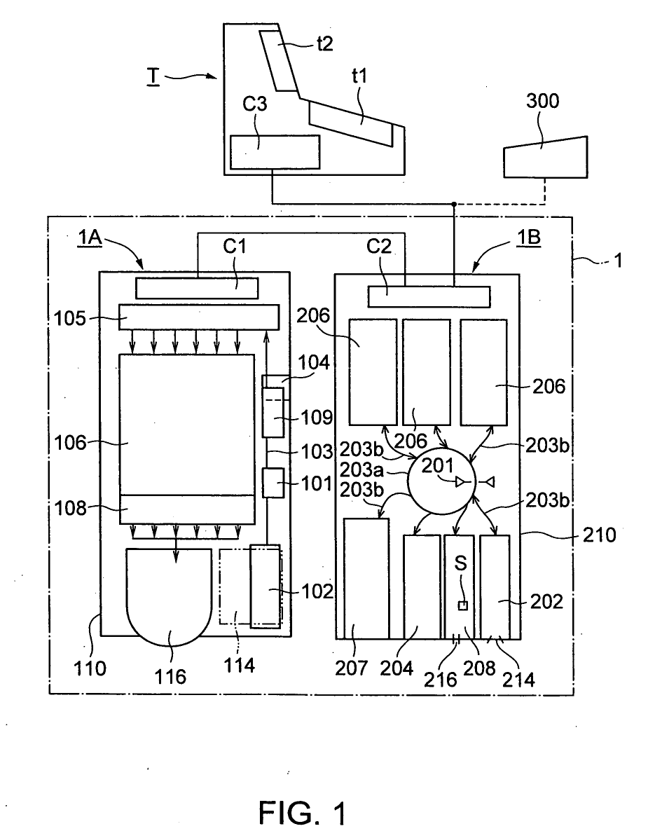

FIG. 1 is a block diagram illustrating an overall configuration of one embodiment of the bill and coin processing system according to the present invention. The bill and coin processing system is exemplified as a system including, roughly, a money repaying apparatus built up by a combination of a coin change discharger (a coin receiving/discharging device) 1A and a bill change discharger (a bill receiving/discharging device) 1B, and by control terminal machine (e.g., a POS register) T for controlling the money repaying apparatus.

The POS register itself is a well-known machine, and hence its in-depth description is omitted. The control terminal machine T according to the present invention is, however, defined as the POS register to which pieces of commercial product information are inputted, and is configured to control the whole of the present system. Therefore, the control terminal machine T includes a key operation unit t1 such as a keyboard, a display unit t2 such as a liquid crystal panel, and a control unit C3. The display unit t2 may have further a touch panel function as the necessity arises.

The coin change discharger 1A and the bill change discharger 1B respectively include control units (controllers) C1, C2. These control units C1, C2 are connected to each other, and the control unit C3 of the control terminal machine T is connected to the control unit C2. Each of the control units C1 through C3 has an interface unit (unillustrated) enabling the information to be exchanged via a communication means, irrespective of a wireless means or a wired means, with the connected devices.

Further, each of the control units has a memory stored with various categories of data and commands, to which the system refers in the following operations as the necessity arises.

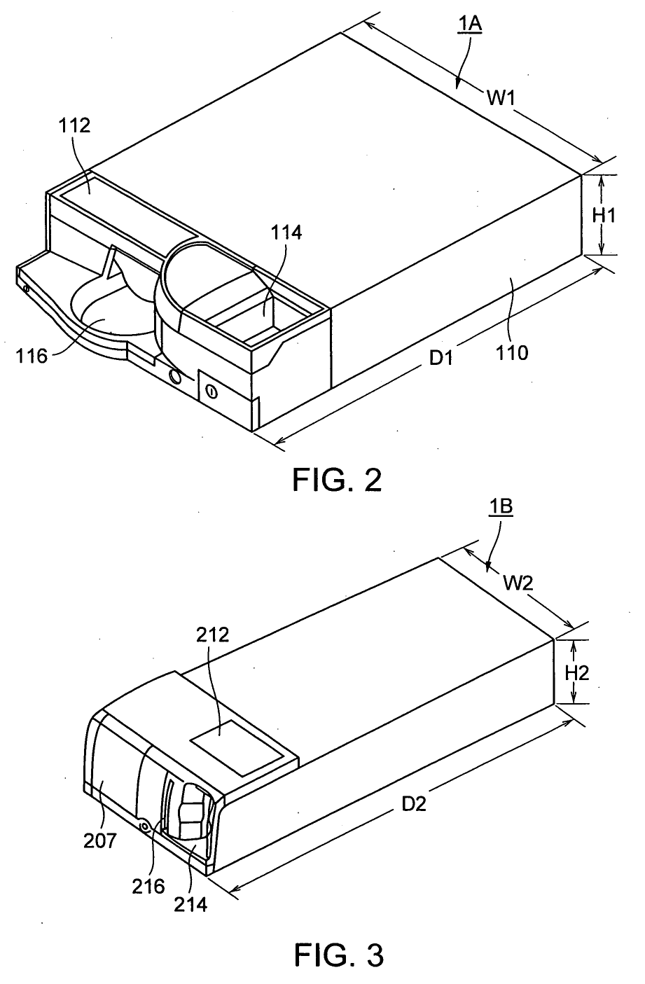

FIG. 2 is a perspective view showing an external appearance of the coin change discharger 1A. FIG. 3 is a perspective view illustrating an external appearance of the bill change discharger 1B. FIGS. 2 and 3 illustrate the coin change discharger 1A and the bill change discharger 1B by way of each single machine taking a separate enclosure. The coin change discharger 1A and the bill change discharger 1B can, however, take a free layout in a way that arranges these machines in a side-by-side relation or in a vertically stacked manner, depending on a state of their installing place and usability. Further, the coin change discharger 1A and the bill change discharger 1B may be connected via wirings to the control terminal machine T in the way of disposing the dischargers 1A, 1B in the vicinity of the machine T and may also connected thereto via the wirings or wirelessly in a way that spaces the dischargers 1A, 1B and the machine T apart.

### (2) Coin Change Discharger 1A

The coin change discharger 1A includes an enclosure 110 having an operation/display unit 112 (FIG. 2) on an upper face of the front part. The coin change discharger 1A includes, as main components thereof, a coin receiving port 114 for receiving coins from outside, a coin discriminating sensor 101 that discriminates between denominations of the receipt coins received from the coin receiving port 114, a coin storing/discharging unit 106 that stores the receipt coins based on a plurality of denominations thereof corresponding to results of the discriminations made by the coin discriminating sensor 101 and has storing/discharging sections from which the coins can be discharged based on a command, a coin discharging unit 108 that discharges a necessary number of coins according to the denominations of the coins from the coin storing/discharging unit 106, and a coin repaying port 116 used for a user to take out the coins aggregated at one portion by hands, which are discharged by the coin discharging unit 108. The coin receiving port 114 and the coin repaying port 116 are provided in the front face of the enclosure 110.

To give a more detailed description, the coin change discharger 1A has a coin feed-in mechanism 102 for feeding in the coins in a single-layer/single-line state, which are received from the coin receiving port 114. A coin carrying path 103 for carrying the coins fed in by the coin feed-in mechanism 102 extends in the rear of the coin feed-in mechanism 102. The coin discriminating sensor 101 for discriminating between the denominations of the coins and a coin rejecting unit 109 for rejecting the reject coins, which will be explained later on, are provided on the halfway of the coin carrying path 103. An in-machine storage box 104 for storing the reject coins rejected therefrom is provided downwardly of the coin rejecting unit 109 in a manner attachable to and detachable from the enclosure 110. Moreover, a collection cassette aiming at not recycling but collecting the coins can also be separately provided.

Further, a denomination selecting unit 105, which selects the coins according to the denominations, is provided downstream of the coin carrying path 103. Still further, the coins are selected in terms of their denominations by the denomination selecting unit 105 and can be stored based on their denominations in the coin storing/discharging unit 106.

The coin storing/discharging unit 106 has storing/discharging portions according to the denominations. The coins stored in the respective storing/discharging portions are selectively fed out and discharged by the coin discharging unit 108. Then, the coins are carried along within the coin carrying path 103 by a carrying belt (unillustrated) provided under each storing unit and discharged into a pay-out port 116.

A size of the coin change discharger 1A is defined by a width W1, a height H1 and a depth D1. Preferably, the width W1 is equal to or smaller than 500 mm, the depth D1 is equal to or smaller than 600 mm, and the height H1 is equal to or smaller than 400 mm.

### (3) Bill Change Discharger 1B

Next, the bill change discharger 1B includes an enclosure 210 having an operation/display unit 212 (FIG. 2) on the upper face of the front part. The bill change discharger 1B includes, as main components thereof, a bill receiving port 214 for receiving bills from outside, a bill discriminating sensor 201 that discriminates between denominations of the receipt bills received from the bill receiving port 214, a bill storing/discharging unit 206 that stores the receipt bills based on denominations thereof corresponding to results of the discriminations made by the bill discriminating unit and has a plurality of storing/discharging sections from which the bills can be discharged based on a command, and a bill repaying port 216 used for the user to take out the bills aggregated at one portion by hands, the bills being discharged via bill discharging means 203a, 203b and 208 discharging a necessary number of bills from the bill storing/discharging unit 206.

To describe the configuration more specifically, the bill change discharger 1B illustrated in FIG. 1 has the above-mentioned main components housed in the enclosure 210, and includes the circulation carrying path 203a taking an annular shape, which is provided substantially at a central portion within the enclosure 210. Further, the enclosure 210 houses a bill feed-in unit 202 for introducing the deposited bills inserted into the receiving port 214 and feeding out the bills accepted from the bill receiving unit towards the circulation carrying path 203a, the bill storing/discharging unit 206 that stores the bills according to the denominations on the basis of the results of the discriminations made by the bill discriminating sensor 201, the bill discharging unit 208 for sending out the bills fed in via the carrying paths 203a, 203b from the respective storing units 206 toward the repaying port 216, a payment reject unit 204 that rejects an abnormal bill when paying the money, and an attachable/detachable bill collecting cassette 207 that stores the collected bills on the occasion of collecting the bills as the necessity arises from within the bill change discharger. These components are disposed in a way that surrounds an outer periphery of the circulation carrying path 203a.

The bill storing/discharging unit 206 serves to store the bills according to the denominations. For example, the Japan-oriented system preferably has three bill storing/discharging units for one thousand-yen bills, five thousand-yen bills and ten thousand-yen notes, or four bill storing/discharging units including a unit for two thousand-yen bills in addition to the above three units. The US-oriented system preferably has four bill storing/discharging units, the three units for, e.g., the denominations having a large amount of circulation such as 1 dollar, 5 dollars, 10 dollars and remaining one unit for mixtures of denominations other than the above among the seven denominations of bills.

The payment reject unit 204 serves to store [payment reject bills], which will be described later on. Further, the collecting cassette 207 serves to store the bills collected from the bill storing/discharging unit 206. The collecting cassette 207 is also used for [overflow bills], which will be explained later on.

The bill discharging unit 208 aggregates the bills fed inside and feeds an aggregation of plural bundled bills (as it is in the case of the single bill) outside from the bill repaying port 216 in a way that partially protrudes therefrom. With this contrivance, the bill repaying port 216 functions as a repaying port for aggregating at one place the bills discharged by the bill discharging means 203a, 203b and 208 and facilitating the take-out (pull-out) of the bills by hands of the user. Note that the bill discharging unit 208 serves also as a deposit reject unit into which [deposit reject bills] explained later on are discharged.

Further, the connection carrying paths 203b for the bills are formed in a one-to-one connecting relation between the circulation carrying path 203a and the bill feed-in unit 202, each of the bill storing/discharging units 206, the bill discharging unit 208, the payment rejecting unit 204 and the collecting cassette 207, respectively. The bill discriminating sensor 201 for discriminating between the denominations of the bills passing through the circulation carrying path 203a is provided at part of the circulation carrying path 203a. It is to be noted that a route switching unit (unillustrated) for switching a bill carrying route between the circulation carrying path 203a and the connection carrying path 203b is disposed along the circulation carrying path 203a.

A size of the bill change discharger 1B is defined by a width W21, a height H2 and a depth D2. Preferably, the width W2 is equal to or smaller than 500 mm, the depth D2 is equal to or smaller than 600 mm, and the height H2 is equal to or smaller than 400 mm.

### (4) Control System

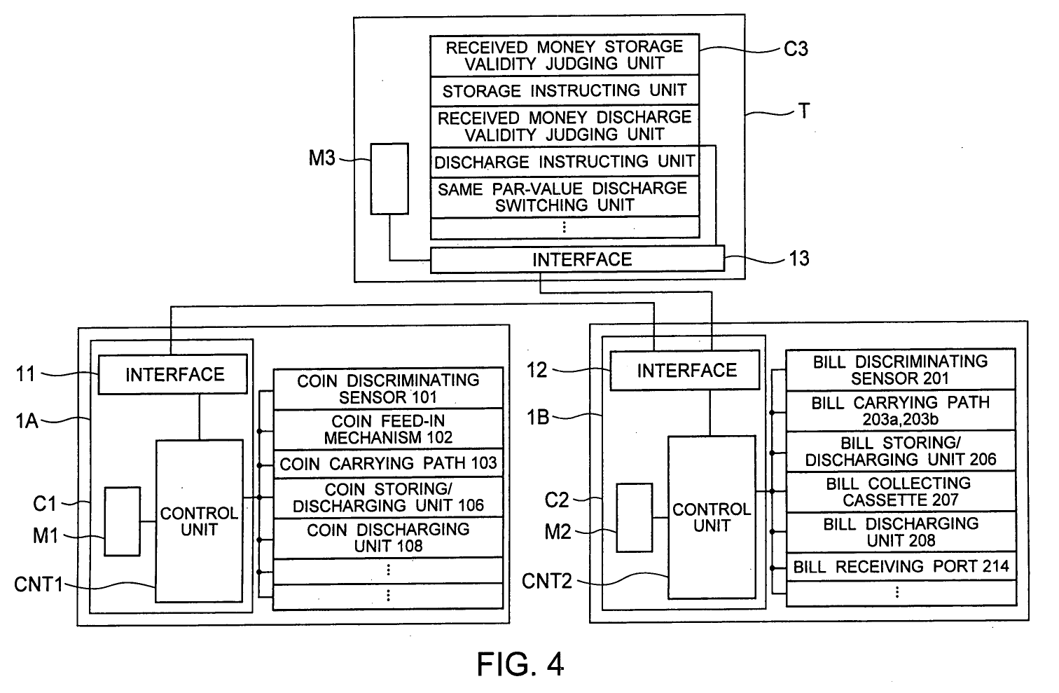

A control system of the bill and coin processing system according to the present invention will be explained with reference to FIG. 4. The control system is built up by the control unit C1 of the coin change discharger 1A, the control unit C2 of the bill change discharger 1B and the control unit C3 of the control terminal machine T. An assumption is that the coin change discharger 1A and the bill change discharger 1B are controlled by the control unit C3 at the POS defined as the control terminal machine T.

The individual control units C1-C3 have, as described above, the interface units I1-I3 enabling the information to be exchanged via the communication means, irrespective of the wireless means or the wired means. The control units C1-C3 also have the memories M1-M3 stored with various categories of data and commands, to which the system refers during the operation as the necessity may arise.

The control unit C1 of the coin change discharger 1A includes a control part CNT1 that controls the coin discriminating sensor 101, the coin feed-in mechanism 102, the coin carrying path 103, the coin storing/discharging unit 106 and the coin discharging unit 108 on the basis of the command given from the control unit C3.

On the other hand, the control unit C2 of the bill change discharger 1B includes a control part CNT2 that controls the bill receiving port 214, the bill discriminating sensor 201, the bill carrying paths 203a and 203b, the bill storing/discharging unit 206, the bill discharging unit 208 and the bill repaying port 216 on the basis of the command given from the control unit C3 of the control terminal machine T.

Further, the control unit C3 of the control terminal machine T includes a received money storage validity judging unit that judges whether the received money may be stored or not, a storage instructing unit that issues a storage instruction to the storing/discharging unit on the basis of the judgment made by the received money storage validity judging unit, a received money discharge validity judging unit that judges whether the stored received money may be discharged or not, and a discharge instructing unit that issues a discharge instruction to the storing/discharging unit on the basis of the judgment made by this received money discharge validity judging unit.

Moreover, it is feasible through the key operation unit t1 of the control terminal machine T to perform a variety of settings about which storing/discharging unit is allocated to a certain denomination and which denomination a certain storing/discharging unit is allocated to, how the coins and the bills showing the same par value are dealt with, whether the recycle is carried out or not, and whether the non-recycle denomination of money is collected or not, and so on.

In this type of control system, the coin change discharger 1A and the bill change discharger 1B are controlled by the control unit C3 in the POS register defined as the high-order control terminal T, whereby a variety of operations such as discharging the change can be executed in multiple modes.

### (5) Layout of Coin Change Discharger 1A and Bill Change Discharger 1B

A variety of embodiments of the bill and coin processing system according to the present invention will hereinafter be described in relation to a layout of the coin change discharger 1A and the bill change discharger 1B.

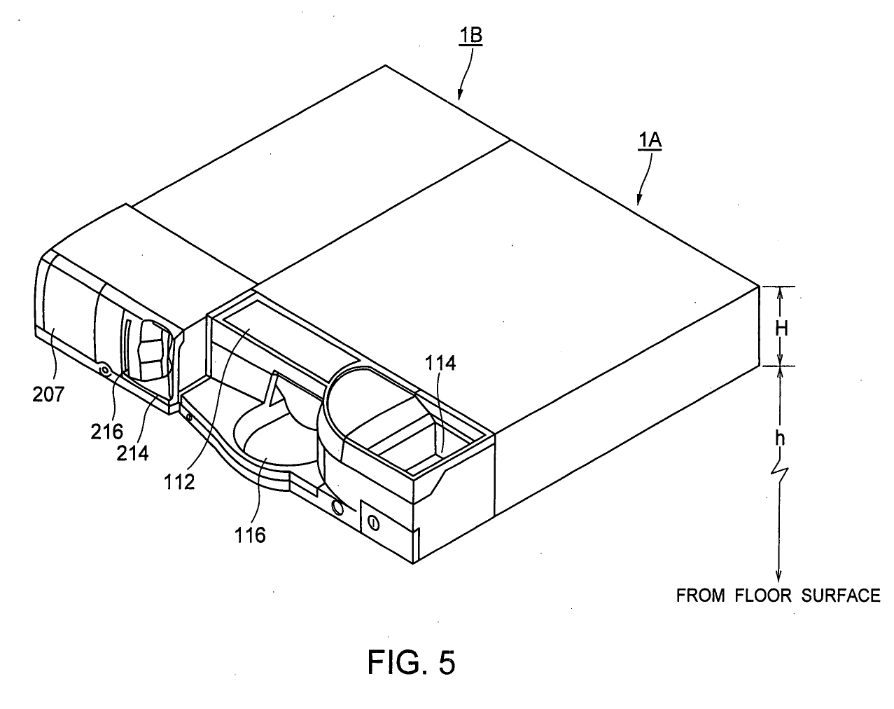

FIG. 5 illustrates a first embodiment of the bill and coin processing system according to the present invention. FIG. 5 shows a layout of the coin change discharger 1A and the bill change discharger 1B, in which the bill change discharger 1B is disposed on the left side as viewed from a customer side, while the coin change discharger 1A is disposed on the right side in such a way that the dischargers 1B and 1A are arranged in a side-by-side relation. In the first embodiment, the heights of the two dischargers are set such as H1=H2=H, and hence these two dischargers can be configured into one integrated body. The width of each of the two dischargers is set equal to or smaller than 500 mm, however, generally the width of the bill change discharger can be set smaller than that of the coin change discharger which needs the coin receiving port 114 and the coin repaying port 116 and is hard to reduce its width. Therefore, when the dischargers 1A and 1B are disposed in the side-by-side relation, a total width thereof can be set well smaller than 1000 mm, and excellent operability is thereby acquired. Further, cabling is simplified by joining these dischargers in the side-by-side relation.

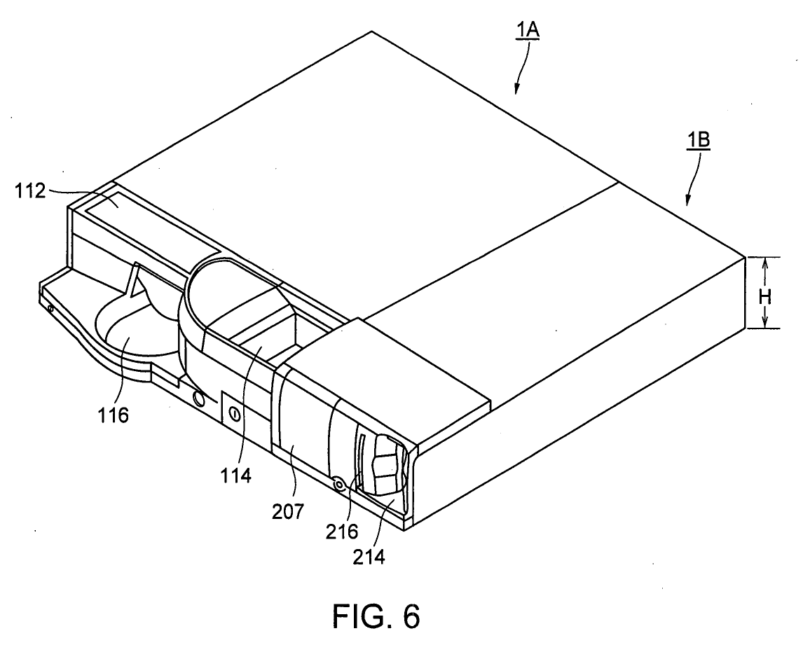

FIG. 6 illustrates a second embodiment of the bill and coin processing system according to the present invention. FIG. 6 shows the layout of the coin change discharger 1A and the bill change discharger 1B, in which the coin change discharger 1A is disposed on the left side as viewed from the customer side, while the bill change discharger 1B is disposed on the right side in such a way that the dischargers 1B and 1A are arranged in the side-by-side relation. In the second embodiment also, the heights of the two dischargers are set such as H1=H2=H, and therefore the two dischargers are configured into one integrated body. In the same way as in the case of FIG. 5, the whole size can be decreased, and the excellent operability is acquired. Further, the cabling is simplified by joining these dischargers in the side-by-side relation.

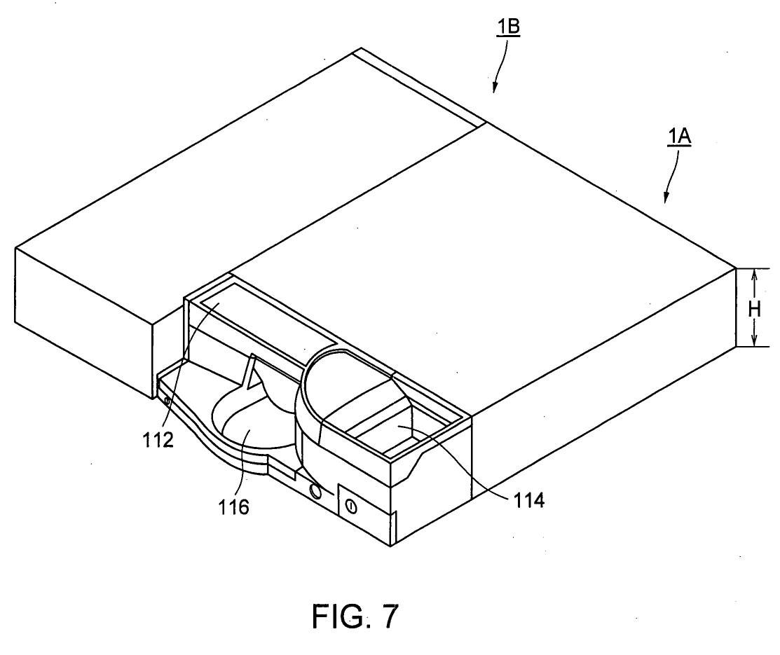

FIG. 7 illustrates a third embodiment of the bill and coin processing system according to the present invention. FIG. 7 shows the layout of the coin change discharger 1A and the bill change discharger 1B, in which the bill change discharger 1B is disposed on the left side as viewed from the customer side, while the coin change discharger 1A is disposed on the right side in such a way that the dischargers 1B and 1A are arranged in the side-by-side relation. Both of the dischargers 1A and 1B are oriented in the directions opposite to each other, in which only the coin change discharger 1A faces on the customer side. This scheme is that only a person in charge deals with the bills.

In the third embodiment also, the heights of the two dischargers are set such as H1=H2=H, and therefore the two dischargers can be configured into one integrated body, the total width can be reduced, and the excellent operability is acquired.

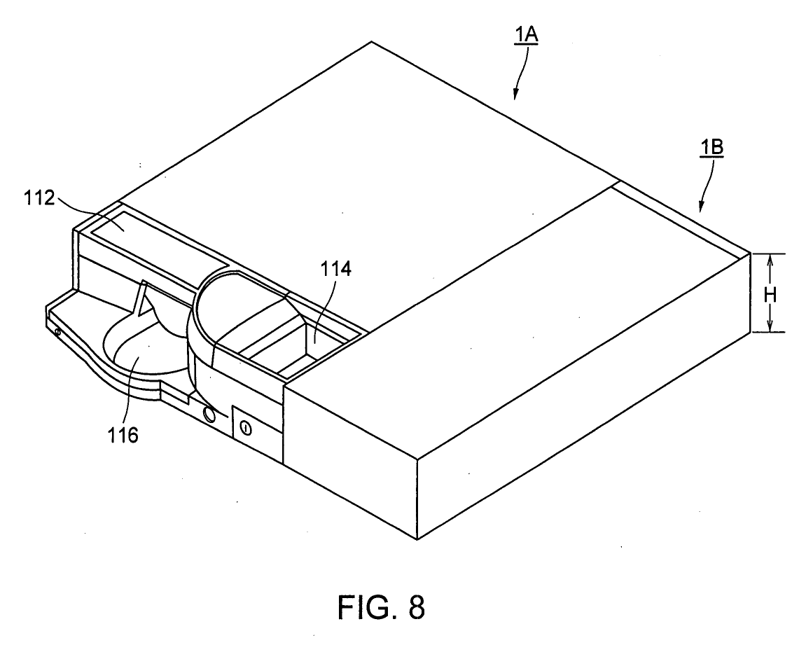

FIG. 8 illustrates a fourth embodiment of the bill and coin processing system according to the present invention. FIG. 8 shows the layout of the coin change discharger 1A and the bill change discharger 1B, in which the coin change discharger 1A is disposed on the left side as viewed from the customer side, while the bill change discharger 1B is disposed on the right side in such a way that the dischargers 1B and 1A are arranged in the side-by-side relation. In the fourth embodiment also, both of the dischargers 1A and 1B are oriented in the directions opposite to each other, in which only the coin change discharger 1A faces toward the customer side.

In the fourth embodiment, in the same way as in the third embodiment in FIG. 7, the total width can be reduced, and the excellent operability is acquired.

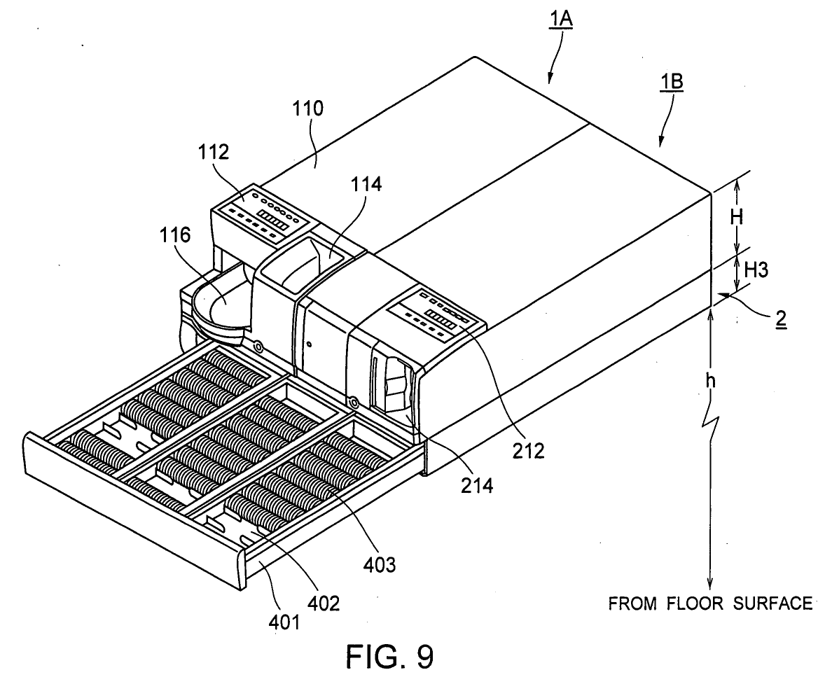

FIG. 9 illustrates a fifth embodiment of the bill and coin processing system according to the present invention. As in the second embodiment, the coin change discharger 1A is disposed on the left side as viewed from the customer side, while the bill change discharger 1B is disposed on the right side in such a way that the dischargers 1B and 1A are arranged in the side-by-side relation. Then, a coin-roll box 2 stored with coin-rolls each consisting of wrapped coins is provided under these discharges.

A size of the coin-roll box 2 is defined by a width W3, a height H3 and a depth D3. As already explained, the apparatus dimension of each of the bill change discharger and the coin change discharger is that the width is equal to or smaller than 500 mm, the depth is equal to or smaller than 600 mm, and the height is equal to or smaller than 400 mm. Hence, a box dimension of the coin-roll box placed under the dischargers arranged in the side-by-side relation be, it is required, 1000 mm or under in width, 600 mm or under in depth and be, it is preferable, 100 mm or under in height.

In this fifth embodiment, the coin-roll box is provided under the whole of the coin change discharger 1A and the bill change discharger 1B arranged in the side-by-side relation, and therefore a comparatively large amount of coin-rolls can the stored therein.

As obvious from the first through fifth embodiments discussed above, the bill and coin processing system according to the present invention can be introduced without involving a large-scale of change in the layout of the installing place, but does not entail any additional costs for the introduction and the installation, and has flexibility enabling the variety of layouts to be chosen responding to demands of the customers and corresponding to the operation modes. Further, the coin change discharger and the bill change discharger are disposed in close proximity to each other, with the result that the cable connection between the two dischargers is simplified, and the simple external appearance can be obtained.

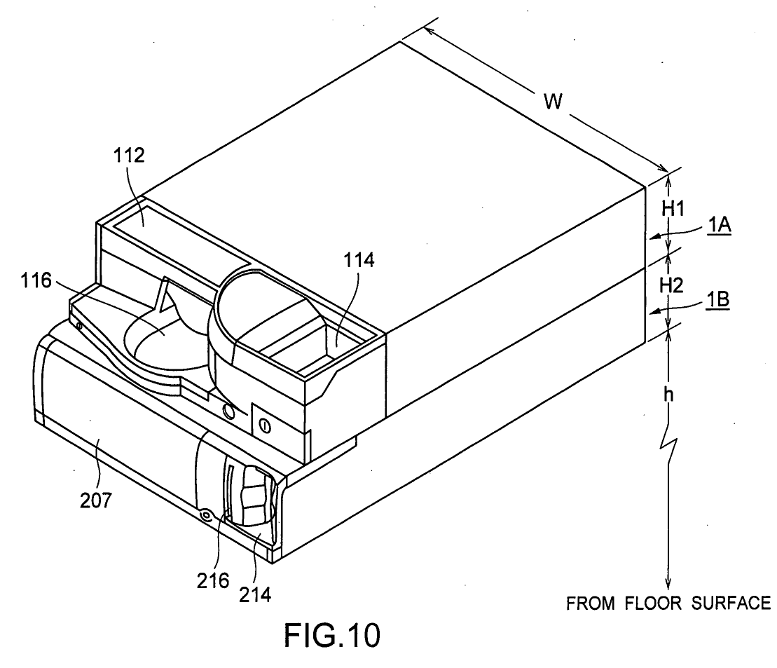

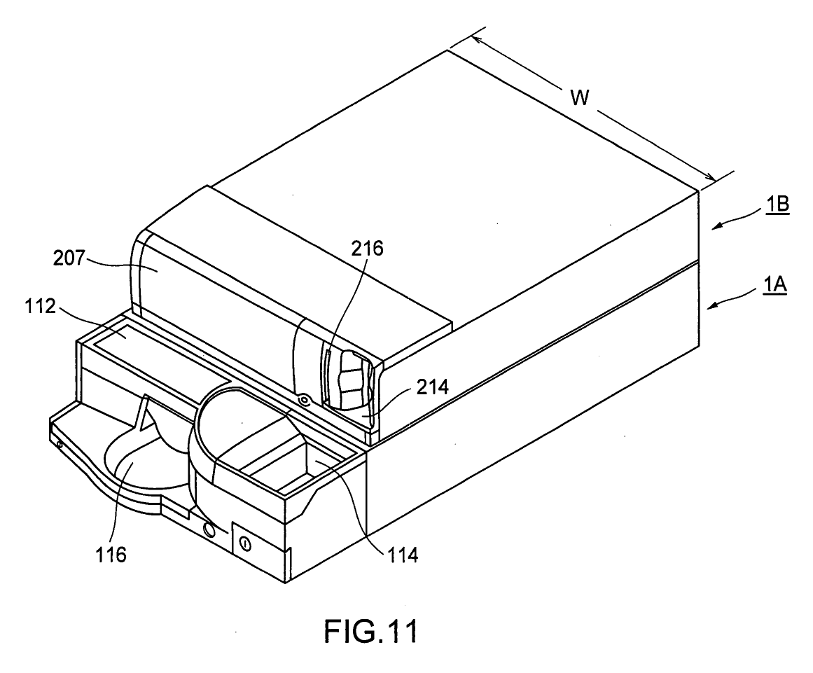

FIG. 10 illustrates a sixth embodiment of the bill and coin processing system according to the present invention. FIG. 10 shows the layout of the coin change discharger 1A and the bill change discharger 1B, in which the coin change discharger 1A is disposed on the upper side, while the bill change discharger 1B is disposed on the lower side in such a way that the discharger 1A is stacked on the discharger 1B. Consequently, the widths of the two dischargers are equalized such as W1=W2=W, whereby the discharger 1A can be stacked on the discharger 1B with stability.

Note that the coin receiving port 114 and the coin repaying port 116 of the coin change discharger 1A are positioned at the front upper portion of the bill change discharger 1B so that the coin change discharger does not hinder the bills from being taken out. Hence, an entire length of the bill change discharger 1B is set larger than an entire length of the coin change discharger 1A.

FIG. 11 illustrates a seventh embodiment of the bill and coin processing system according to the present invention. FIG. 11 shows the layout of the coin change discharger 1A and the bill change discharger 1B, in which the bill change discharger 1B is disposed on the upper side, while the coin change discharger 1A is disposed on the lower side in such a way that the discharger 1B is stacked on the discharger 1A. In this case also, the widths of the two dischargers are equalized such as W1=W2=W, whereby the discharger 1B can be stacked on the discharger 1A with the stability.

Moreover, the bill change discharger 1B is positioned backward from the coin receiving port 114 and the coin repaying port 116 of the coin change discharger 1A so that the bill change discharger 1B does not hinder the coins from being taken out of the coin change discharger 1A.

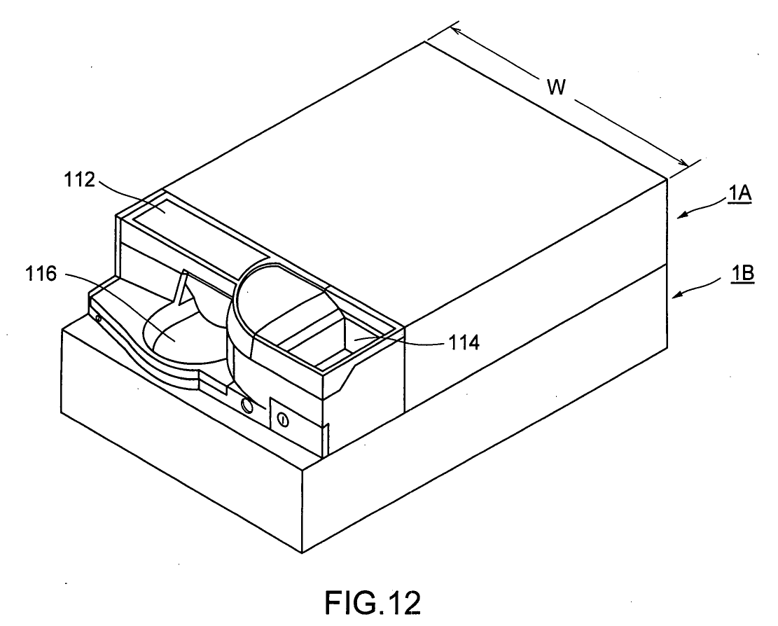

FIG. 12 illustrates an eighth embodiment of the bill and coin processing system according to the present invention. FIG. 12 shows the layout of the coin change discharger 1A and the bill change discharger 1B, in which the coin change discharger 1A is, in the same way as in the case of FIG. 10, disposed on the upper side, while the bill change discharger 1B is disposed on the lower side in such a way that the discharger 1A is stacked on the discharger 1B. A different point from FIG. 10 is that the directions of the coin change discharger 1A and of the bill change discharger 1B are reversed.

In this case also, the widths of the two dischargers are equalized such as W1=W2=W, whereby the discharger 1A can be stacked on the discharger 1B with the stability. Moreover, in the same way as in the seventh embodiment, the coin receiving port 114 and the coin repaying port 116 of the coin change discharger 1A are positioned at the rear upper portion of the bill change discharger 1B.

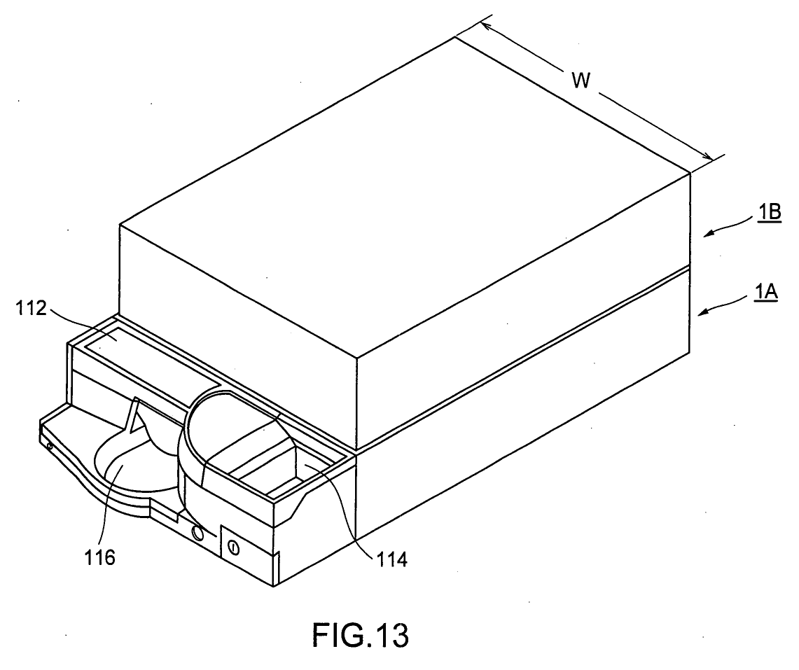

FIG. 13 illustrates a ninth embodiment of the bill and coin processing system according to the present invention. FIG. 13 shows the layout of the coin change discharger 1A and the bill change discharger 1B, in which the bill change discharger 1B is disposed on the upper side, while the coin change discharger 1A is disposed on the lower side in such a way that the discharger 1B is stacked on the discharger 1A by reversing the directions of the two dischargers. In this case also, the widths of the two dischargers are equalized such as W1=W2=W, whereby the discharger 1B can be stacked on the discharger 1A with the stability.

Moreover, the bill change discharger 1B is positioned backward from the coin receiving port 114 and the coin repaying port 116 of the coin change discharger 1A so that the bill change discharger 1B does not hinder the coins from being taken out of the coin change discharger 1A.

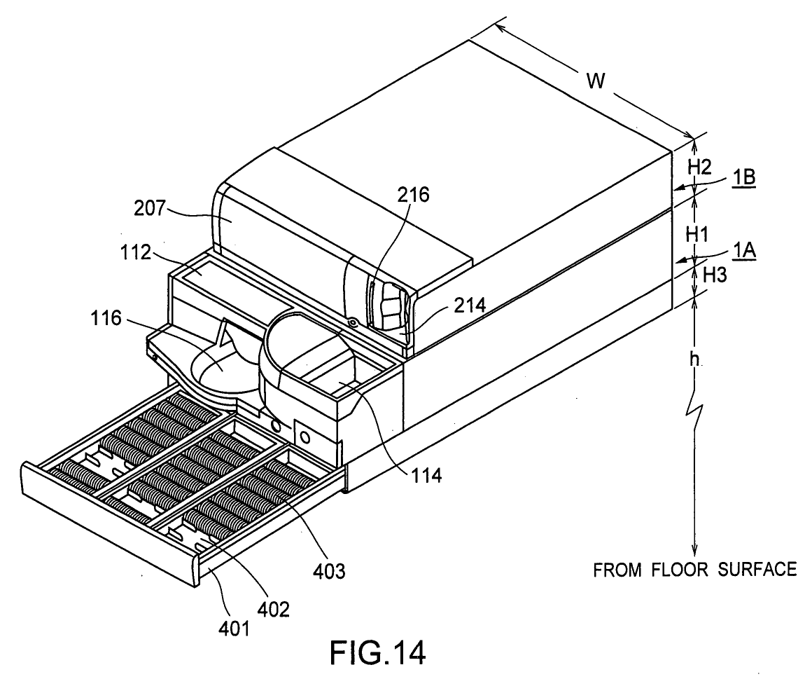

FIG. 14 illustrates a tenth embodiment of the bill and coin processing system according to the present invention. As in the seventh embodiment, the bill change discharger 1B is disposed on the upper side, while the coin change discharger 1A is disposed on the lower side so that the discharger 1B is stacked on the discharger 1A, wherein the coin-roll box 2 as explained with reference to FIG. 9 is positioned under the discharger 1A.

As described in the fifth embodiment, it is preferable that the box dimension of the coin-roll box be 1000 mm or under in width, 600 mm or under in depth and 100 mm or under in height. In the tenth embodiment, the respective widths W1, W2, W3 of the coin change discharger 1A, the bill change discharger 1B and the coin-roll box 1C are equalized such as W1=W2=W3, whereby the discharger 1B can be stacked on the discharger 1A in a compact configuration on the whole.

As apparent from the sixth through tenth embodiments discussed above, the bill and coin processing system according to the present invention enables the change dischargers to be stacked in the vertical direction by regulating the sizes of the constructive apparatuses. Hence, the bill and coin processing system can be introduced in a way that neither accompanies the large change in the layout of the installing place nor requires the large installing area, which does not take the additional costs for the introduction and the installation. In addition, the bill and coin processing system has the flexibility enabling the variety of layouts to be selected responding to the demands of the customers and corresponding to the operation modes. Further, the coin change discharger and the bill change discharger are disposed in close proximity to each other, with the result that the cable connection between the two dischargers is simplified, and the simple external appearance can be obtained.

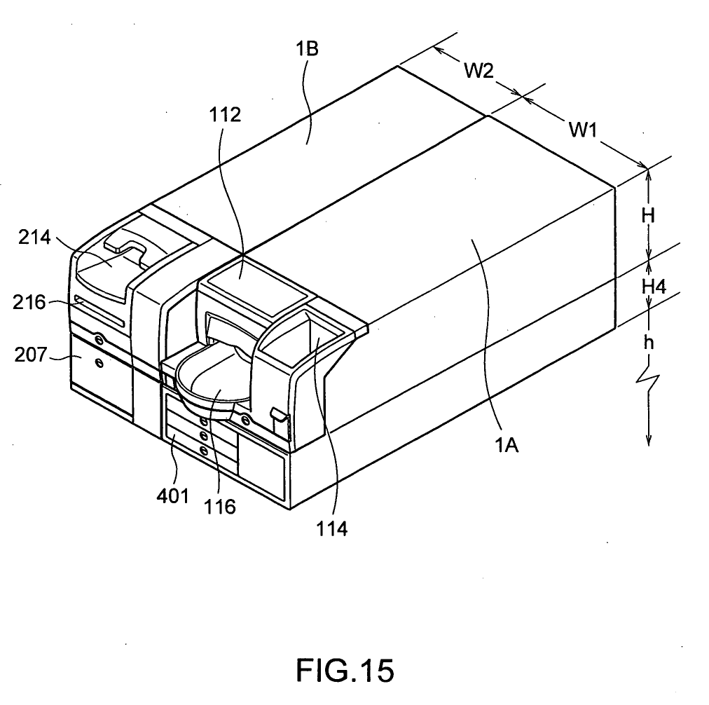

FIG. 15 illustrates an eleventh embodiment of the bill and coin processing system according to the present invention. In the eleventh embodiment, the bill change discharger 1B and the coin change discharger 1A are arranged in the side-by-side relation in the horizontal direction, in which the bill change discharger 1B is disposed on the left side, while the coin change discharger 1A is disposed on the right side.

Herein, the bill change discharger 1B is constructed as a vertical type bill receiving/discharging machine, in which a receiving port 214, a repaying port 216 and a bill cassette 207 are arranged in the vertical direction. The coin change discharger 1A includes the operation/display unit 112, the coin receiving port 114 and the coin repaying port 116. The coin change discharger 1A is constructed as a coin receiving/discharging machine provided integrally with a storage box 401 at the lower part. In the eleventh embodiment, a height of the storage box 401 and a height of the bill cassette 207 are set at H4.

Next, the sizes and the layouts of the respective change dischargers will be considered.

Referring again to FIG. 5 and subsequent drawings, in each of the embodiments, the money input/output ports of the bill change discharger and of the coin change discharger are disposed in the predetermined range, i.e., disposed in positions, which are 700 mm-1500 mm in height from a floor surface. The heights of the money input/output ports and the bottom face positions of the coin change discharger and of the bill change discharger are as highly close as within a several centimeters. Therefore, the following discussion will be made on the assumption that “h” is the height, from the floor surface, of the bottom face of each of the coin change discharger and the bill change discharger.

The coin change discharger and the bill change discharger as illustrated in FIGS. 5 through 8 are arranged in the side-by-side relation, in which case a height relation is given such as:

700<h, (h+H)<1500

In the case of FIG. 15 showing the layout that the coin change discharger 1A provided integrally with the coin-roll box and the bill change discharger are arranged in the side-by-side relation, the height relation is given as follows:

700<h, (h+H+H4)<1500

In the case of the stacked configuration as illustrated in FIGS. 10-13, the height relation is given such as:

700<h, (h+H1+H2)<1500

Thus, the heights h, H, H1, H2 and H4 may be properly selected so as to satisfy these relations.

Note that if the coin-roll box becomes a further stacking object, in the case of FIG. 9, the height relation is given such as:

700<h, (H+H+H3)<1500

and, in the case of FIG. 14, the height relation is given such as:

700<h, (h+H1+H2+H3)<1500

where h, H, H1, H2 and H3 may be properly chosen so as to satisfy these relations.

If the relations given above are satisfied, the heights of the money input/output ports of the bill change discharger and of the coin change discharger are set so as to facilitate most the take-in and take-out of the money by the person in charge of the cash register and the customer, whereby the operability can be improved.

Incidentally, if strict heights need setting, a technique may be such that let h′ be a distance between the bottom face and the money input/output port of each of the coin change discharger and the bill change discharger, and h in each inequality described above is replaced by (h+h′).

The embodiments discussed above are the exemplifications, the wordings in the appended claims shall embrace modifications and changes that are normally implemented by those skilled in the art. Examples of the embodiments of the present invention will hereinafter be given.
1. A bill and coin processing system comprising:

a bill change discharger constructed as a bill receiving/discharging machine; and

a coin change discharger constructed as a coin receiving/discharging machine,

wherein a machine dimension of each of said bill change discharger and said coin change discharger is that a width is equal to or smaller than 500 mm, a depth is equal to or smaller than 600 mm, and a height is equal to or smaller than 400 mm.
2. A bill and coin processing system according to example 1, wherein each of said bill change discharger and said coin change discharger includes storing units on a denomination-by-denomination basis.
3. A bill and coin processing system according to example 2, wherein currencies dealt with by said bill change discharger and said coin change discharger are dollars and cents of U.S. currencies.
4. A bill and coin processing system according to example 1, wherein said bill change discharger and said coin change discharger are connected via a communication line to an upper cash register, and

a necessary amount of change is paid out of said bill change discharger or said coin change discharger in response to a command from said cash register.
5. A bill and coin processing system according to example 1, wherein said bill change discharger and said coin change discharger are coincident with each other in terms of at least any one of the width, the depth and the height.
6. A bill and coin processing system according to example 5, wherein said bill change discharger and said coin change discharger are coincident in their heights and are disposed in a side-by-side relation in a horizontal direction.
7. A bill and coin processing system according to example 6, wherein directions of said bill change discharger and of said coin change discharger are coincident with each other, and

said bill change discharger is disposed on the right side as viewed from a customer side.
8. A bill and coin processing system according to example 6, wherein the directions of said bill change discharger and of said coin change discharger are coincident with each other, and

said bill change discharger is disposed on the left side as viewed from the customer side.
9. A bill and coin processing system according to example 6, wherein the directions of said bill change discharger and of said coin change discharger are opposite to each other, and

said bill change discharger is disposed on the right side as viewed from the customer side.
10. A bill and coin processing system according to example 6, wherein the directions of said bill change discharger and of said coin change discharger are opposite to each other, and

said bill change discharger is disposed on the left side as viewed from the customer side.
11. A bill and coin processing system according to example 5, wherein said bill change discharger and said coin change discharger are coincident with each other in terms of at least in their widths and are stacked on each other.
12. A bill and coin processing system according to example 11, wherein the directions of said bill change discharger and said coin change discharger are coincident with each other, and

said coin change discharger is stacked on said bill change discharger.
13. A bill and coin processing system according to example 12, wherein the depth of said coin change discharger is set so that a money receiving port and a money repaying port of said coin change discharger are positioned above at the front portion of said bill change discharger.
14. A bill and coin processing system according to example 11, wherein the directions of said bill change discharger and said coin change discharger are coincident with each other, and

said bill change discharger is stacked on said coin change discharger.
15. A bill and coin processing system according to example 14, wherein a front edge portion of said bill change discharger recedes from the positions of the money receiving port and the money repaying port of said coin change discharger.
16. A bill and coin processing system according to example 11, wherein the directions of said bill change discharger and of said coin change discharger are opposite to each other, and

said coin change discharger directed toward the customer side is stacked on said bill change discharger.
17. A bill and coin processing system according to example 16, wherein the depth of said coin change discharger is set so that the money receiving port and the money repaying port of said coin change discharger are positioned above at the rear portion of said bill change discharger.
18. A bill and coin processing system according to example 11, wherein the directions of said bill change discharger and of said coin change discharger are opposite to each other, and

said bill change discharger is stacked on said coin change discharger directed toward the customer side.
19. A bill and coin processing system according to example 18, wherein a rear edge portion of said bill change discharger recedes from the positions of the money receiving port and the money repaying port of said coin change discharger.
20. A bill and coin processing system comprising:

a bill change discharger constructed as a bill receiving/discharging machine; and

a coin change discharger constructed as a coin receiving/discharging machine,

wherein money input/output ports of said bill change discharger and of said coin change discharger are disposed in positions, which are 700 mm through 1500 mm in height from a floor surface.
21. A bill and coin processing system according to example 20, wherein a machine dimension of each of said bill change discharger and said coin change discharger is that a width is equal to or smaller than 500 mm, a depth is equal to or smaller than 600 mm, and a height is equal to or smaller than 400 mm.
22. A bill and coin processing system according to example 21, wherein each of said bill change discharger and said coin change discharger includes storing units on a denomination-by-denomination basis.
23. A bill and coin processing system according to example 22, wherein currencies dealt with by said bill change discharger and said coin change discharger are dollars and cents of U.S. currencies.
24. A bill and coin processing system according to example 21, wherein said bill change discharger or said coin change discharger is connected via a communication line to an upper cash register, and

a necessary amount of change is paid out of said bill change discharger or said coin change discharger in response to a command from said cash register.
25. A bill and coin processing system according to example 21, wherein said bill change discharger and said coin change discharger are coincident with each other in terms of at least any one of the width, the depth and the height.
26. A bill and coin processing system according to example 25, wherein said bill change discharger and said coin change discharger are coincident in their heights and are disposed in a side-by-side relation in a horizontal direction.
27. A bill and coin processing system according to example 26, wherein directions of said bill change discharger and of said coin change discharger are coincident with each other, and

said bill change discharger is disposed on the right side as viewed from a customer side.
28. A bill and coin processing system according to example 26, wherein the directions of said bill change discharger and of said coin change discharger are coincident with each other, and

said bill change discharger is disposed on the left side as viewed from the customer side.
29. A bill and coin processing system according to example 26, wherein the directions of said bill change discharger and of said coin change discharger are opposite to each other, and

said bill change discharger is disposed on the right side as viewed from the customer side.
30. A bill and coin processing system according to example 26, wherein the directions of said bill change discharger and of said coin change discharger are opposite to each other, and

said bill change discharger is disposed on the left side as viewed from the customer side.
31. A bill and coin processing system according to example 25, wherein said bill change discharger and said coin change discharger are coincident with each other in terms of at least in their widths and are stacked on each other.
32. A bill and coin processing system according to example 31, wherein the directions of said bill change discharger and said coin change discharger are coincident with each other, and

said coin change discharger is stacked on said bill change discharger.
33. A bill and coin processing system according to example 32, wherein the depth of said coin change discharger is set so that a money receiving port and a money repaying port of said coin change discharger are positioned above at the front portion of said bill change discharger.
34. A bill and coin processing system according to example 31, wherein the directions of said bill change discharger and said coin change discharger are coincident with each other, and

said bill change discharger is stacked on said coin change discharger.
35. A bill and coin processing system according to example 34, wherein a front edge portion of said bill change discharger recedes from the positions of the money receiving port and the money repaying port of said coin change discharger.
36. A bill and coin processing system according to example 31, wherein the directions of said bill change discharger and of said coin change discharger are opposite to each other, and

said coin change discharger directed toward the customer side is stacked on said bill change discharger.
37. A bill and coin processing system according to example 36, wherein the depth of said coin change discharger is set so that the money receiving port and the money repaying port of said coin change discharger are positioned above at the rear portion of said bill change discharger.
38. A bill and coin processing system according to example 31, wherein the directions of said bill change discharger and of said coin change discharger are opposite to each other, and

said bill change discharger is stacked on said coin change discharger directed toward the customer side.
39. A bill and coin processing system according to example 38, wherein a rear edge portion of said bill change discharger recedes from the positions of the money receiving port and the money repaying port of said coin change discharger.
40. A bill and coin processing system comprising:

a bill change discharger constructed as a bill receiving/discharging machine;

a coin change discharger constructed as a coin receiving/discharging machine; and

a coin-roll box installed under said bill change discharger and said coin change discharger,

wherein a machine dimension of each of said bill change discharger and said coin change discharger is that a width is equal to or smaller than 500 mm, a depth is equal to or smaller than 600 mm, and a height is equal to or smaller than 400 mm, and

a box dimension of said coin-roll box is that a width is equal to or smaller than 1000 mm, a depth is equal to or smaller than 600 mm, and a height is equal to or smaller than 100 mm.
41. A bill and coin processing system according to example 40, wherein each of said bill change discharger and said coin change discharger includes storing units on a denomination-by-denomination basis.
42. A bill and coin processing system according to example 41, wherein currencies dealt with by said bill change discharger and said coin change discharger are dollars and cents of U.S. currencies.
43. A bill and coin processing system according to example 40, wherein any one of said bill change discharger, said coin change discharger and said coin-roll box is connected via a communication line to an upper cash register, and

a necessary amount of change is paid out of said bill change discharger or said coin change discharger in response to a command from said cash register.
44. A bill and coin processing system according to example 40, wherein said bill change discharger and said coin change discharger are coincident with each other in terms of at least any one of the width, the depth and the height.
45. A bill and coin processing system according to example 44, wherein said bill change discharger and said coin change discharger are coincident in their heights and are disposed in a side-by-side relation in a horizontal direction.
46. A bill and coin processing system according to example 45, wherein directions of said bill change discharger and of said coin change discharger are coincident with each other, and

said bill change discharger is disposed on the right side as viewed from a customer side.
47. A bill and coin processing system according to example 45, wherein the directions of said bill change discharger and of said coin change discharger are coincident with each other, and

said bill change discharger is disposed on the left side as viewed from the customer side.
48. A bill and coin processing system according to example 45, wherein the directions of said bill change discharger and of said coin change discharger are opposite to each other, and

said bill change discharger is disposed on the right side as viewed from the customer side.
49. A bill and coin processing system according to example 45, wherein the directions of said bill change discharger and of said coin change discharger are opposite to each other, and

said bill change discharger is disposed on the left side as viewed from the customer side.
50. A bill and coin processing system according to example 44, wherein said bill change discharger and said coin change discharger are coincident with each other in terms of at least in their widths and are stacked on each other.
51. A bill and coin processing system according to example 50, wherein the directions of said bill change discharger and said coin change discharger are coincident with each other, and

said coin change discharger is stacked on said bill change discharger.
52. A bill and coin processing system according to example 51, wherein the depth of said coin change discharger is set so that a money receiving port and a money repaying port of said coin change discharger are positioned above at the front portion of said bill change discharger.
53. A bill and coin processing system according to example 50, wherein the directions of said bill change discharger and said coin change discharger are coincident with each other, and

said bill change discharger is stacked on said coin change discharger.
54. A bill and coin processing system according to example 53, wherein a front edge portion of said bill change discharger recedes from the positions of the money receiving port and the money repaying port of said coin change discharger.
55. A bill and coin processing system according to example 50, wherein the directions of said bill change discharger and of said coin change discharger are opposite to each other, and

said coin change discharger directed toward the customer side is stacked on said bill change discharger.
56. A bill and coin processing system according to example 55, wherein the depth of said coin change discharger is set so that the money receiving port and the money repaying port of said coin change discharger are positioned above at the rear portion of said bill change discharger.
57. A bill and coin processing system according to example 50, wherein the directions of said bill change discharger and of said coin change discharger are opposite to each other, and

said bill change discharger is stacked on said coin change discharger directed toward the customer side.
58. A bill and coin processing system according to example 57, wherein a rear edge portion of said bill change discharger recedes from the positions of the money receiving port and the money repaying port of said coin change discharger.
59. A bill and coin processing system comprising:

a bill change discharger constructed as a bill receiving/discharging machine; and

a coin change discharger constructed as a coin receiving/discharging machine and including a coin-roll box formed integrally with said coin change discharger,

wherein a machine dimension of said bill change discharger is that a width is equal to or smaller than 500 mm, a depth is equal to or smaller than 600 mm, and a height is equal to or smaller than 400 mm, and

a machine dimension of said coin change discharger is that a width is equal to or smaller than 500 mm, a depth is equal to or smaller than 600 mm, and a height is equal to or smaller than 550 mm.
60. A bill and coin processing system according to example 59, wherein said bill change discharger and said coin change discharger are coincident with each other in terms of at least any one of the width, the depth and the height.
61. A bill and coin processing system according to example 59, wherein said bill change discharger and said coin change discharger are coincident in their heights and are disposed in a side-by-side relation in a horizontal direction.

What is claimed is:

1. A bill and coin processing system comprising:
a bill change discharger constructed as a bill receiving/discharging machine; and
a coin change discharger constructed as a coin receiving/discharging machine,
wherein a machine dimension of each of said bill change discharger and said coin change discharger is that a width is equal to or smaller than 500 mm, a depth is equal to or smaller than 600 mm, and a height is equal to or smaller than 400 mm.

2. A bill and coin processing system according to claim 1, wherein each of said bill change discharger and said coin change discharger includes storing units on a denomination-by-denomination basis, and
currencies dealt with by said bill change discharger and said coin change discharger are dollars and cents of U.S. currencies.

3. A bill and coin processing system according to claim 1, wherein said bill change discharger and said coin change discharger are coincident with each other in terms of at least any one of the width, the depth and the height.

4. A bill and coin processing system according to claim 3, wherein said bill change discharger and said coin change discharger are coincident in their heights and are disposed in a side-by-side relation in a horizontal direction.

5. A bill and coin processing system according to claim 4, wherein the directions of said bill change discharger and of said coin change discharger are opposite to each other, and
said bill change discharger is disposed on the right side as viewed from the customer side.

6. A bill and coin processing system according to claim 4, wherein said bill change discharger and said coin change discharger are coincident with each other in terms of at least in their widths and are stacked on each other.

7. A bill and coin processing system comprising:
a bill change discharger constructed as a bill receiving/discharging machine; and
a coin change discharger constructed as a coin receiving/discharging machine,
wherein money input/output ports of said bill change discharger and of said coin change discharger are disposed in positions, which are 700 mm through 1500 mm in height from a floor surface.

8. A bill and coin processing system according claim 7, wherein a machine dimension of each of said bill change discharger and said coin change discharger is that a width is equal to or smaller than 500 mm, a depth is equal to or smaller than 600 mm, and a height is equal to or smaller than 400 mm.

9. A bill and coin processing system according to claim 8, wherein each of said bill change discharger and said coin change discharger includes storing units on a denomination-by-denomination basis, and
currencies dealt with by said bill change discharger and said coin change discharger are dollars and cents of U.S. currencies.

10. A bill and coin processing system according to claim 9, wherein said bill change discharger and said coin change discharger are coincident with each other in terms of at least any one of the width, the depth and the height.

11. A bill and coin processing system according to claim 10, wherein said bill change discharger and said coin change discharger are coincident in their heights and are disposed in a side-by-side relation in a horizontal direction.

12. A bill and coin processing system according to claim 11, wherein the directions of said bill change discharger and of said coin change discharger are opposite to each other, and
said bill change discharger is disposed on the right side as viewed from the customer side.

13. A bill and coin processing system according to claim 10, wherein said bill change discharger and said coin change discharger are coincident with each other in terms of at least in their widths and are stacked on each other.

14. A bill and coin processing system comprising:
a bill change discharger constructed as a bill receiving/discharging machine;
a coin change discharger constructed as a coin receiving/discharging machine; and
a coin-roll box installed under said bill change discharger and said coin change discharger,
wherein a machine dimension of each of said bill change discharger and said coin change discharger is that a width is equal to or smaller than 500 mm, a depth is equal to or smaller than 600 mm, and a height is equal to or smaller than 400 mm, and
a box dimension of said coin-roll box is that a width is equal to or smaller than 1000 mm, a depth is equal to or smaller than 600 mm, and a height is equal to or smaller than 100 mm.

15. A bill and coin processing system according to claim 14 wherein each of said bill change discharger and said coin change discharger includes storing units on a denomination-by-denomination basis, and
currencies dealt with by said bill change discharger and said coin change discharger are dollars and cents of U.S. currencies.

16. A bill and coin processing system according to claim 14, wherein said bill change discharger and said coin change discharger are coincident with each other in terms of at least any one of the width, the depth and the height.

17. A bill and coin processing system according to claim 16, wherein said bill change discharger and said coin change discharger are coincident in their heights and are disposed in a side-by-side relation in a horizontal direction.

18. A bill and coin processing system according to claim 17, wherein the directions of said bill change discharger and of said coin change discharger are opposite to each other, and
said bill change discharger is disposed on the right side as viewed from the customer side.

19. A bill and coin processing system according to claim 16, wherein said bill change discharger and said coin change discharger are coincident with each other in terms of at least in their widths and are stacked on each other.

20. A bill and coin processing system comprising:
a bill change discharger constructed as a bill receiving/discharging machine; and
a coin change discharger constructed as a coin receiving/discharging machine and including a coin-roll box formed integrally with said coin change discharger,
wherein a machine dimension of said bill change discharger is that a width is equal to or smaller than 500 mm, a depth is equal to or smaller than 600 mm, and a height is equal to or smaller than 400 mm, and
a machine dimension of said coin change discharger is that a width is equal to or smaller than 500 mm, a depth is equal to or smaller than 600 mm, and a height is equal to or smaller than 550 mm.

21. A bill and coin processing system according to claim 20, wherein said bill change discharger and said coin change discharger are coincident with each other in terms of at least any one of the width, the depth and the height.

22. A bill and coin processing system according to claim 20, wherein said bill change discharger and said coin change discharger are coincident in their heights and are disposed in a side-by-side relation in a horizontal direction.
